(19) United States
(12) Patent Application Publication
(10) Pub. No.: US 2013/0094012 A1
(43) Pub. Date: Apr. 18, 2013

(54) METHOD AND APPARATUS FOR MEASURING THE FLOW VELOCITY BY MEANS OF A PLASMA

(71) Applicant: AIRBUS OPERATIONS GMBH, Hamburg (DE)

(72) Inventors: Peter PEUSER, Riemerling (DE); Bernd PFINGSTEN, Aidlingen (DE)

(73) Assignee: AIRBUS OPERATIONS GMBH, Hamburg (DE)

(21) Appl. No.: 13/669,750

(22) Filed: Nov. 6, 2012

Related U.S. Application Data
(63) Continuation of application No. PCT/EP2011/057313, filed on May 6, 2011.

(30) Foreign Application Priority Data
May 6, 2010 (DE) 10 2010 019 811.0

(51) Int. Cl. G01F 1/66

(52) U.S. Cl. CPC G01F 1/661; G01F 1/663; G01F 1/666
USPC 356/28; 73/861.18; 73/861.01; 73/861.27

(57) ABSTRACT

A method and device for measuring the flow speed of a fluid, in one example, of air, is provided. The method and device include the use of laser radiation, in which, by means of at least one laser beam pulse focused in the fluid flow in the radiation focus a plasma is formed, and the acoustic and/or optical effects occurring during plasma formation are acquired, and from them the flow speed of the fluid is determined

### CROSS-REFERENCE TO RELATED APPLICATIONS

This is a continuation of International Application No. PCT/EP2011/057313, filed May 6, 2011, which claims priority to German Patent Application No. 10 2010 019 811.0, filed on May 6, 2010, which are hereby incorporated by reference in their entirety.

### TECHNICAL FIELD

The present disclosure relates to a method and to a device for measuring the flow speed of fluids, in particular of gases, and to the use of such a device.

### BACKGROUND

In flow measuring technology, for determining the flow speeds of fluids generally, and in particular of gases such as air, various measuring methods are used. In this context, the impeller anemometer is a particularly simple measuring device. Also in widespread use are so-called thermal flow sensors, for example the hot-film anemometer or the constant-temperature anemometer.

More elaborate methods use laser radiation, as is the case, for example, in particle image velocimetry. In this process the speed and the direction of carried-along particles are determined by means of the backscattered laser radiation. In this process the flow is temporarily exposed in one plane. From the comparison of two images the displacement or shift of the individual particles can be determined, wherein this information can then be used for calculating the speed fields.

Likewise, in laser Doppler anemometry, the scatter of the laser radiation as a result of the particles present in the airflow is used for measuring the air speed.

So-called lidar methods are particularly elaborate measuring techniques that have been developed for turbulence measuring. In this process the short-pulse laser radiation is detected that is backscattered from aerosols or molecules.

A particularly important field of application of flow measuring technology relates to speed measuring in aircraft, where up to now predominantly the so-called pitot measuring principle has been used in which a pitot tube is arranged in the air flow. Because of this measuring principle in conjunction with the exposed position of the pitot tube, namely protruding from the external wall of an aircraft, said measuring principle is, however, prone to dirt, insects water and icing, which may result in incorrect measured values or even in total failure of speed measurement.

Pitot tubes are also used in fast-moving motor vehicles when a measured speed value is required that is independent of the rotational speed of the wheels.

Apart from the very expensive measuring technology of a directly-detecting lidar system, in the other measuring methods it is either necessary for particles to be present in the air or for the airflow to be influenced or even disturbed by installed measuring probes, which may result in measurement errors.

In addition, other objects, desirable features and characteristics will become apparent from the subsequent summary and detailed description, and the appended claims, taken in conjunction with the accompanying drawings and this background.

### SUMMARY

Accordingly, it is desirable, with little construction expenditure and low susceptibility to faults, to precisely determine the flow speed of a fluid, in one example, of an airflow, without this requiring the presence of particles in the airflow, or without this requiring a flow-disturbing measuring probe to be placed into the flow.

According to the various teachings of the present disclosure, a method is provided to determine a flow speed of a fluid that includes by means of at least one focused laser beam in the radiation focus a plasma is formed in the fluid, and the acoustic and/or optical effects occurring during plasma formation are acquired, and from them the flow speed is determined

Furthermore, according to another exemplary embodiment, a device for measuring the flow speed of a fluid, with the device comprising at least one impulse laser with a high impulse power with a focusing device for generating a radiation focus in the fluid and a plasma in the radiation focus, further comprising at least one detector device for acquiring acoustic and/or optical effects that occur during plasma formation, as well as a control unit for controlling the impulse laser and for acquiring and analyzing the signals of the at least one detector device and for determining the flow speed from the acquired signals.

By generating at least one focused laser beam impulse, it is possible to generate in the focal point intensities of several tens of gigawatts/cm². Consequently, in the fluid in the immediate near field of the focal point, a plasma arises which is then located directly in the flowing fluid, i.e. it is part of the fluid and is easily detectable, both acoustically and optically. The influence of the flowing fluid on the plasma or on the interaction between the plasma and the fluid then makes it possible, by means of the plasma, to measure the flow speed of the fluid relative to the detector.

The laser-generated plasma provides a practically ideal point source for sound emission or radiation emission. In this process the flow is not influenced or disturbed in any way, because there is no need to place objects into the flowing medium. As a result of the short temporal characteristic of the plasma generated by a short-pulse laser, which plasma in the case of air has a typical lifespan in the range of about 10 ns, very accurate measurements, in one example, time measurements during sound propagation, are made possible. The present disclosure supports a measuring accuracy of better than one per mil.

In order to generate the laser impulse, by means of a focusing lens, a short-pulse laser beam is radiated into a measuring space in which the fluid to be measured flows. In this arrangement the focal point of the focused laser beam is established so as to be at an adequate distance from the boundary of the measuring space so that influencing the flowing fluid as a result of boundary effects can largely or entirely be prevented. Suitable laser radiation may, generally, be provided by means of a miniaturized pulsed solid-state laser which, generally, has a pulse power in the order of several megawatts. Such pulse power result in a laser with a pulse length in the range of a few nanoseconds, and pulse energies of several millijoules. If such a laser beam is focused, the above-mentioned intensities in the range of several tens of gigawatts/cm² may be achieved in the focus, and consequently the plasma arises in the focal point. The plasma generates a sound pulse, and thus generates an ideal punctiform sound source. The present disclosure thus makes it possible to achieve speed measuring independently of the presence of any particles, and is suitable, in one example, for speed measurements of flowing air.

In one of various exemplary embodiments, the laser pulse or the plasma pulse is used as a start impulse, and the stop impulse is provided by a sound sensor, e.g. a microphone, which comprises as high as possible a boundary frequency in the region of at least about 20 kHz. In this arrangement the stop impulse may be defined at an accuracy of better than about 1 μs. Thus, by means of a time measuring system the transit time of the acoustic wave front from the starting location plasma to the sound detector may be determined very accurately. Due to the so-called entrainment effect (i.e. addition of the vectors of the sound speed and of the flow speed) during sound propagation in a gaseous or liquid medium flowing at a determined speed, in this way the flow speed of the medium may be measured. If, for example, the sound detector in the case of air, when viewed in the direction of flow, is arranged upstream of and laterally of the plasma, and if the distance between the plasma sound source and the detector is, for example, approximately 0.5 m, then the transit time of the sound impulse is several milliseconds even at relatively low flow speeds of less than about 0.2 Mach. The method is suitable for measuring very high flow speeds up to the region of the speed of sound with very high accuracy.

The present disclosure is thus above all suitable for measuring the speed in gases, above all in air. According to one exemplary embodiment, the present disclosure relates to measuring the speed of aircraft to replace the hitherto-used speed meters comprising pitot measuring tubes.

According to the various teachings of the present disclosure, the acoustic impulse arising during plasma formation is acquired, and from the time period between the laser impulse and the acquired acoustic impulse the flow speed of the fluid is determined Thus the propagation speed of the powerful acoustic impulse that arises during plasma formation is measured in that the short laser impulse with an accuracy of less than about 1 ns provides the start impulse, and a sound detector, in one example, a microphone or a pressure sensor, installed at a suitable position at the boundary of the measuring space, acquires the incoming acoustic impulse. The time between the starting impulse and the measured sound impulse, acquired at the microphone, is a measure of the propagation speed of the sound. The propagation speed of the acoustic impulse now depends on the flow speed of the fluid, and thus the flow speed may be determined from the predetermined fixed distances (from the focal point to the microphone) and the measured time difference. In this arrangement it is advantageous that the sound speed does not depend on the air pressure, nor on the humidity of the air, so that the measuring method can also be used at high altitudes and in clouds in the application as a speed measuring device of an aircraft.

According to the various teachings of the present disclosure, the sound impulse is acquired at several acquisition points arranged downstream of the beam focus, and from it the flow speed in the supersonic range is determined In this case, in the supersonic range, the so-called Mach cone forms, wherein the following relationship applies to the aperture angle of the cone: sin α=c/v, wherein c denotes the speed of sound, and v denotes the flow speed. In this arrangement the opening angle of the Mach cone decreases when the flow speed increases. At lower flow speeds, i.e. larger aperture angles of the cone, the surface of the cone impinges on those sound detectors that are arranged closest to the focal point (the plasma). The higher the flow speed, the smaller the aperture angle becomes, and the surface of the cone impinges on the sound detectors that are arranged further downstream. In this case the detectors arranged further upstream do not receive a signal. Thus, corresponding to the number and the distance of the sound detectors, a particular set of detectors can be assigned to each supersonic speed range and, consequently, determining the speed becomes possible.

According to another exemplary embodiment, the temperature of the fluid is measured, and the flow speed is determined taking into account the fluid temperature, because the speed of sound depends on the temperature of the fluid.

Another exemplary embodiment provides that the sound impulse arising during plasma formation is acquired at two different positions, spaced apart from each other in the direction of flow, and based on the measured transit time differences the flow speed in the subsonic range is determined. In one example, two microphones are installed at the same distance upstream and downstream of the laser focus.

Another exemplary embodiment of the present disclosure provides that the sound impulse arising during plasma formation is acquired and subjected to an acoustic frequency analysis, and from the frequency shift due to the Doppler effect the flow speed is determined For this purpose, again, by means of a measuring microphone the acoustic impulse is acquired and fed to a frequency analyzer. From the measured frequency shift the flow speed can then be calculated.

In order to obtain an optimal signal-to-noise ratio, it is, advantageously, also possible to use a so-called lock-in method, in other words a phase-sensitive detection method, which in the case of periodic signals provides significant advantages. To this effect, generally for a defined measuring period, for example about 10 seconds, a sequence of laser impulses at a pulse repetition rate ranging from about 10 Hz to about 1,000 Hz is generated.

Another exemplary embodiment of the present disclosure provides that the optical impulse arising during plasma formation is acquired and subjected to a spectrum analysis, and from the frequency shift due to the Doppler effect the flow speed is determined. To this effect the optical signal is acquired by means of an optical lens system installed in, or behind, the wall of the measuring space, and is, for example, by means of an optical fiber fed to a spectrometer. Due to the frequency shift determined by means of discrete Fourier transformation, the flow speed of the fluid can be determined, because for example at a flow speed (e.g. a flight speed) of about 360 km/h with a laser wavelength of about 1 μm, a frequency shift in the region of approximately one GHz results, which may be acquired with great accuracy.

According to the various teachings of the present disclosure, several of the measuring principles described above may be coupled together in order to increase the measuring accuracy or operational safety. For example, it is possible to measure both the sound impulse arising during plasma formation, and to measure the optical impulse.

Furthermore, it is possible to combine several of the individual exemplary embodiments based on the same physical principle. For example, speed detection based on the transit time difference between the generated impulse and a measuring point may be coupled with the determination principle based on the transit time difference between two acoustic sensors. Or the arrangement for the acoustic acquisition of the plasma impulse in the subsonic range is combined with the system for the supersonic range.

According to another exemplary embodiment of the present disclosure, a device for measuring the flow speed of a fluid comprises at least one impulse laser with a high impulse power with a focusing assembly for generating a radiation focus in the fluid and a plasma in the radiation focus, furthermore at least one detector device for acquiring acoustic and/or optical effects occurring during plasma formation, and a control unit for controlling the impulse laser and for acquiring and analyzing the signals of the at least one detector device, and for determining the flow speed from the acquired signals.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 a diagrammatic view of an exemplary embodiment of the present disclosure for speed measuring in a gas with acoustic detectors for the subsonic range;

FIG. 2 a diagrammatic view of another exemplary embodiment of the present disclosure for speed measuring in a gas with acoustic detectors for the supersonic range;

FIG. 3 a diagrammatic view of another exemplary embodiment of the present disclosure for speed measuring in a gas with an optical detector;

FIG. 4 a diagram that shows a frequency shift in acoustic measuring; and

FIG. 5 a diagram that shows discrete Fourier transformations of two acoustic spectra.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

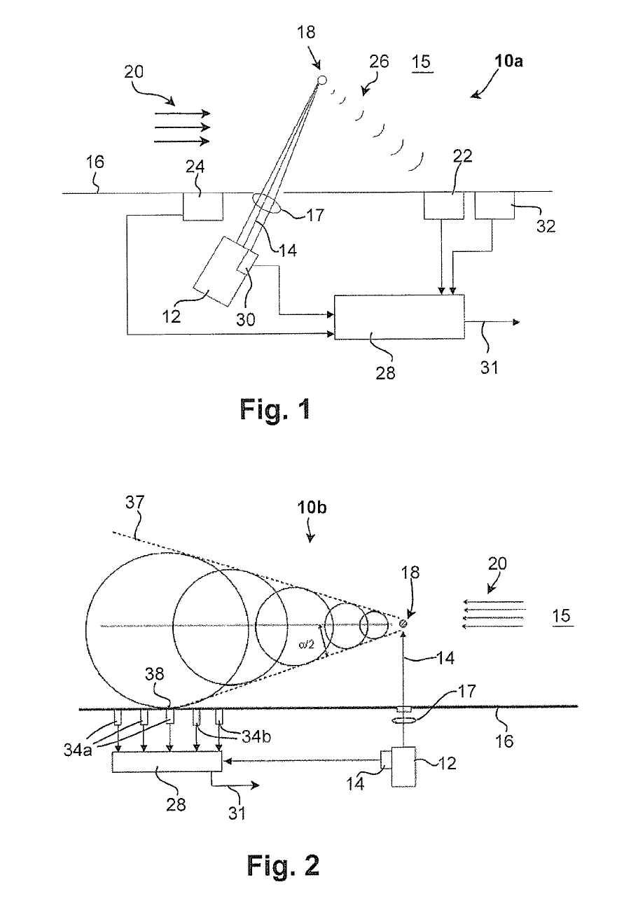

In one of various exemplary embodiments of the present disclosure 10a, which exemplary embodiment is shown in FIG. 1, comprises a short-pulse laser 12 that is generally designed as a solid-state laser 12, in one example, as an Nd:YAG laser whose laser beam 14 is directed to a measuring space 15 through which gas flows, and by means of a focusing lens 17, arranged in the region of the measuring space wall, is bundled in a radiation focus 18. With the use of a laser wavelength of approximately 1064 nm, based on strong focusing, it is possible to achieve laser safety already approximately 2 m behind the plasma. As an alternative, with the use of a wavelength in the eye-safe range, in one example, at approximately 1500 nm, radiation that is stronger by 6 orders of magnitude can be used, or laser safety can be achieved practically in the near region of the plasma.

In this exemplary arrangement the radiation focus 18 is adequately far away from the measuring space wall 16 to avoid boundary effects. A gas flows through the measuring space 15 in the direction designated 20. The gas whose speed is measured is generally air.

The short-pulse laser 12 generally has a pulse power ranging from about 1 to about 10 MW with a pulse length ranging from about 1 to about 10 ns so that in the radiation focus 18 an intensity ranging from about 10 to about 100 GW/cm² arises. Consequently, because of a laser impulse in the immediate surroundings of the radiation focus 18 a plasma forms in the measuring space 15. The plasma generates a punctiform sound source. An acoustic detector 22, generally a pressure sensor or a measuring microphone, acquires the incoming sound impulse 26 and feeds it to a control unit 28.

Furthermore, to the short-pulse laser 12 a photo diode 30 has been mounted which detects the laser impulse 14 and also feeds the signal to the control unit 28. As an alternative it is also possible for a corresponding electronic impulse signal to be tapped directly at the short-pulse laser 12. The control unit 28 comprises a time-to-amplitude converter or some other time measuring system on whose start input the signal of the photo diode 30 or some other electronic impulse signal of the laser on whose stop input the signal of an acoustic detector 22 is present so that the time between the start impulse and the stop impulse is measured. Since the distance between the beam focus 18 and the acoustic detector 22 is defined, based on the measured time difference the flow speed in the measuring space 20 may be calculated and a corresponding speed signal 31 may be output. Furthermore, in one example, a temperature sensor 32 is provided whose signal is also fed to the control unit 28 and by means of which temperature sensor 32 the temperature of the gas in the measuring space 20 is measured. Since the speed of sound depends on the temperature of the gas, by way of temperature measuring a correction of the speed determined from the time difference can be carried out. The speed of sound is temperature-dependent according to the following equation:

c=331.5*∞(1+T/273,15)

The acoustic detector 22 is in one example, a pressure sensor so that very short signals in the microsecond range can be acquired.

Furthermore, a second acoustic detector 24 may be provided, which is offset in the direction of flow 20 relative to the first acoustic detector 22 so that from the time difference between the signals of the two detectors 22, 24 the flow speed of the gas can be determined. Provided the two detectors 22, 24 are arranged in each case at the same distance upstream and downstream of the focal point 18, with the gas at a standstill (no flow speed) there is no transit time difference between the signals of the two detectors 22, 24. Any flow thus causes an evaluable time difference between the signals of the two detectors 22, 24.

As an alternative the acoustic detector 22 (and/or the detector 24) may be designed as a microphone, in which case the control unit 28 comprises an acoustic frequency analyzer in order to acquire the frequency spectrum of the microphone signal by means of a discrete Fourier transformation, and from it to determine the Doppler frequency shift. From the frequency shift f′ the speed v may be determined by means of the relation:

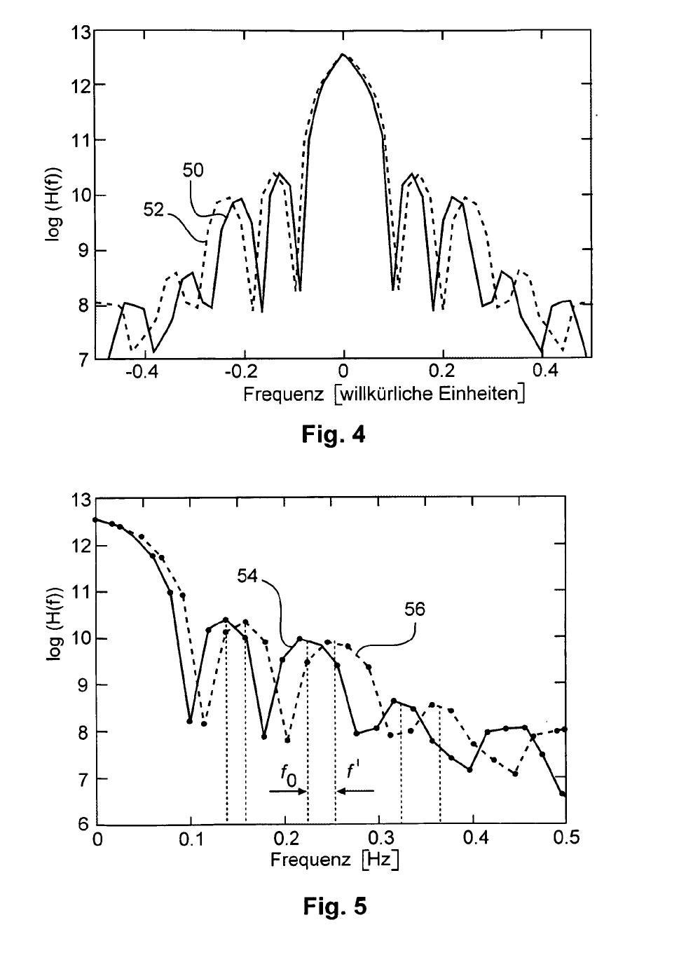

f′=f₀*(1/(1−v/c))

wherein c denotes the speed of sound, and f₀ denotes the frequency at speed 0. FIG. 4 shows an example.

FIG. 2 shows another exemplary embodiment 10b that differs from the exemplary embodiment according to FIG. 1 in that downstream of the focal point 18 a number of acoustic or pressure-sensitive sensors 34 are arranged that are connected to the control unit 28. In this arrangement the flowing air 20 flows from right to left and impinges on the punctiform plasma sound source in the focal point 18. The Mach cone forms, wherein the following relationship applies to the aperture angle of the cone: sin α=c/v, wherein c denotes the speed of sound and v denotes the flow speed. On the measuring space wall 16, which extends parallel to the direction of flow 20, downstream, i.e. behind the plasma sound source 18, several sound sensors 34 are arranged in a line one behind the other, which sound sensors 34 are installed in such a manner that the airflow is not influenced. At lower supersonic flow speeds, i.e. larger aperture angles of the cone, the cone mantle 37 impinges on those sound detectors that are arranged furthest to the right. The higher the flow speed, the smaller the aperture angle a becomes, and the surface 37 of the cone impinges on the acoustic detectors 34a arranged downstream, i.e. in the image further to the left. The detectors 34b arranged upstream then do not receive a signal. Thus, corresponding to the number and the distance of the sound detectors 34, a particular set of detectors 34a may be assigned to each supersonic speed range and, consequently, determining the speed in the supersonic range becomes possible. The exemplary embodiments of FIGS. 1 and 2, or the respective arrangements of the detectors 22, 24, 34 may also generally be combined in order to obtain speed measurement in the subsonic range and in the supersonic range.

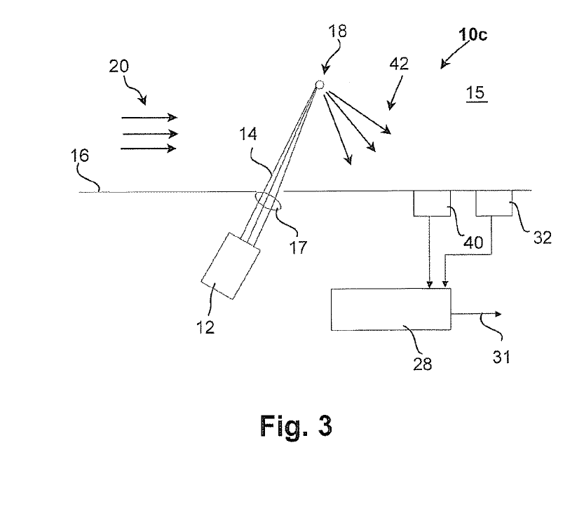

FIG. 3 shows another exemplary embodiment 10c for signal acquisition by means of an optical detector 40 whose signal is fed to the control unit 28. The plasma formed in the focal point 18 sends electromagnetic radiation 42 inter alia to the optical detector 40. In the control unit 28 an analysis of the optical signal takes place. In one exemplary embodiment the control unit 28 comprises a wavelength measuring unit that determines the main area of the optical spectrum of the acquired radiation 42, and measures it with the stored value at no flow of the gas at all. Since the plasma is taken along from the focal point 18 by the gas flow, thus a relative movement of the plasma in the direction of flow 20 relative to the optical detector 40 takes place so that because of the Doppler effect a frequency shift of the radiation spectrum is measured. Furthermore, a temperature sensor 32 is provided, whose signal is also fed to the control unit 28 and by means of which the temperature of the gas in the measuring space 20 is measured. By means of the equation mentioned further above, the speed of sound is corrected with reference to the measured fluid temperature.

As an alternative or in addition, the control unit 28 may comprise a spectrometer unit, as a result of which the wavelength shift of the spectral lines relative to the flow-free state may be determined in the measuring space 15.

It should be noted that in all cases of optical radiation passing through the measuring space wall 16 corresponding optical windows (not shown) are provided in order to separate the fluid flow in the measuring space from the space with the measuring apparatus.

FIG. 4 shows two diagrams, wherein an acoustic frequency spectrum 50, obtained by means of discrete Fourier transformation, at speed zero is shown in a dashed line, and a frequency spectrum 52 at a flow speed greater than zero is shown. The curves comprise a maximum as well as several smaller lateral maxima, arranged symmetrically to the aforesaid, which are artifacts resulting from so-called aliasing effects. The frequency spectrum 52 is spread when compared to the frequency spectrum 50 in the direction of a higher frequency, which corresponds to a higher downstream flow speed (measured by means of the detector 22 in FIG. 1).

FIG. 5 shows two diagrams of frequency spectra 54, 56, obtained by means of discrete Fourier transformations, wherein the dashed frequency spectrum 56 shows the signal at a flow speed greater than zero. The flow speed v may be determined by means of the equation:

v=c*(1−f₀/f′)

wherein c denotes the speed of sound, f₀ denotes the frequency at speed zero, and f′ denotes the measured frequency.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

What is claimed is:

1. A method for measuring the flow speed of a fluid, comprising:
focusing at least one laser beam impulse in the fluid flow and forming a plasma in the radiation focus;
acquiring of at least one of acoustic effects and optical effects occurring during plasma formation; and
determining the flow speed of the fluid from the acquired at least one of acoustic effects and optical effects.

2. The method of claim 1, further comprising:
acquiring a sound impulse arising during plasma formation; and
determining from a time period between the at least one laser impulse and the acquired sound impulse the flow speed.

3. The method of claim 2, wherein acquiring the sound impulse further comprises:
acquiring the sound impulse at several acquisition points arranged downstream of the radiation focus; and
from the acquired sound impulse, determining the flow speed in the supersonic range.

4. The method of claim 2, further comprising:
measuring the temperature of the fluid; and
determining the flow speed taking into account the fluid temperature.

5. The method of claim 2, wherein acquiring the sound impulse further comprises:
acquiring the sound impulse at two positions spaced apart from each other in the direction of flow; and
based on the measured transit time difference, determining the flow speed in the subsonic range.

6. The method of claim 2, wherein acquiring the sound impulse further comprises:
subjecting the acquired sound impulse to a frequency analysis; and
determining the flow speed from the frequency shift due to a Doppler effect.

7. The method of claim 5, further comprising:
generating a sequence of laser beam impulses;
performing a frequency analysis and phase analysis on the resulting sound impulses; and
determining the flow speed based on the results of the frequency analysis and phase analysis.

8. The method of claim 1, further comprising:
acquiring an optical impulse arising during plasma formation;
subjecting the acquired optical impulse to a spectrum analysis; and
determining the flow speed from the frequency shift due to a Doppler effect.

9. The method of claim 1, wherein acquiring of at least one of acoustic effects and optical effects occurring during plasma formation further comprises:
acquiring both acoustic effects and optical effects occurring during plasma formation; and
determining the flow speed based on the acquired acoustic effects and optical effects.

10. A device for measuring the flow speed of a fluid, comprising:
at least one impulse laser with a focusing assembly for generating a radiation focus in the fluid and a plasma in the radiation focus;
at least one detector device that acquires at least one of acoustic effects and optical effects occurring during plasma formation; and
a control unit that controls the impulse laser, acquires and analyzes the signals of the at least one detector device and determines the flow speed from the acquired signals.

11. The device of claim 10, further comprising at least one acoustic detector.

12. The device of claim 11, wherein the at least one acoustic detector further comprises a plurality of acoustic detectors arranged one behind the other downstream of the radiation focus, and the flow speed in the supersonic range is determined based on a signal acquired from one of the plurality of acoustic detectors that is located furthest upstream.

13. The device of claim 10, further comprising at least one temperature sensor.

14. The device of claim 10, further comprising at least one optical detector.

15. The device of claim 10, wherein the device is used for measuring the speed of a motor vehicle.

16. The device of claim 15, wherein the motor vehicle is an aircraft.
